(19) United States
(12) Patent Application Publication
(10) Pub. No.: US 2026/0077462 A1
(43) Pub. Date: Mar. 19, 2026

(54) SPECIAL-PURPOSE VALVE CORE REMOVAL TOOL

(71) Applicant: DE ZHANG, RUI'AN (CN)

(72) Inventors: DE ZHANG, RUI'AN (CN); HONGWEI WANG, RUI'AN (CN)

(21) Appl. No.: 18/985,436

(22) Filed: Dec. 18, 2024

(30) Foreign Application Priority Data
Sep. 14, 2024 (CN) 202422259590.1

(51) Int. Cl. B25B 27/24

(52) U.S. Cl. CPC B25B 27/24

(57) ABSTRACT

Disclosed is a special-purpose valve core removal tool, including a tool body and a hexagon wrench with a tapered extractor. The tool body is detachably connected to the hexagon wrench and includes square opening portions, hexagon portions, and a clamping portion. Multiple square opening portions and hexagon portions of different specifications are arranged axially along the tool body. An internal hexagon through hole is formed in the middle section of the tool body. The internal hexagon through hole radially penetrates through the tool body. The clamping portion is radially arranged in the tool body and transversely moves along the internal hexagon through hole. The hexagon wrench is extendable to the internal hexagon through hole to be clamped with the clamping portion. Through the above structure, the problem that in a disassembling and assembling process, it is needed to replace tool heads with different sizes many times is solved.

### TECHNICAL FIELD

The present disclosure relates to the technical field of removal tools, and in particular to a special-purpose valve core removal tool.

### BACKGROUND

For valve cores that are faulty or have corroded over time in valve bodies, it is necessary to promptly remove the valve cores from the valve bodies. Due to the narrow space between the valve body and the valve core, it may be difficult to remove the valve core or impossible to complete disassembly and maintenance operations during replacement.

Existing removal tools are mainly scattered manual tools. In a disassembling and assembling process, it is needed to replace tool heads with different sizes many times. It is hard, labor-wasting, and strenuous to remove the valve core corroded in the removal process.

It can be seen that apparently, the above existing removal tools still have inconveniences and defects, and need to be further improved. How to create a new valve core removal tool that can remove the valve core from the valve body smoothly has become a goal that urgently needs improvement in the current industry.

### SUMMARY

The technical problem to be solved by the present disclosure is to provide a special-purpose valve core removal tool that can remove a valve core from a valve body smoothly, thereby overcoming the problem that in a disassembling and assembling process, it is needed to replace tool heads with different sizes many times.

In order to overcome the above technical problem, the present disclosure provides a special-purpose valve core removal tool, including: a tool body and a hexagon wrench with a tapered extractor, where the tool body is detachably connected to the hexagon wrench;
the tool body includes square opening portions, hexagon portions, and a clamping portion, where multiple square opening portions and hexagon portions of different specifications are arranged axially along the tool body, an internal hexagon through hole is formed in a middle section of the tool body, the internal hexagon through hole radially penetrates through the tool body, and the clamping portion is radially arranged in the tool body and transversely moves along the internal hexagon through hole; and
the hexagon wrench is extendable to the internal hexagon through hole to be clamped with the clamping portion.

As an improvement of the present disclosure, the hexagon wrench includes a hexagonal handle, the tapered extractor is arranged at one end of the hexagonal handle, a first locking groove and a second locking groove are radially formed in a concave manner in both ends of the hexagonal handle, the first locking groove is formed at an end close to the tapered extractor, and the second locking groove is formed at the other end; and
the hexagon wrench extends into the internal hexagon through hole, and the clamping portion is clamped with the first locking groove or the second locking groove.

As an improvement of the present disclosure, the clamping portion includes:
a sliding groove hole, a release pin, a sealing jack screw, and an elastic member, where the sliding groove hole is transversely formed in the tool body and is communicated with the internal hexagon through hole;
the release pin slides along the sliding groove hole and one side of the release pin extends into the sliding groove hole and is clamped with the hexagon wrench; and
the sealing jack screw is arranged at one end of the sliding groove hole, and the elastic member is arranged between the release pin and the sealing jack screw and abuts against the release pin and the sealing jack screw, respectively.

As an improvement of the present disclosure, one end of the release pin extends out of the sliding groove hole, the release pin is provided with a bump, and the bump slides along an inner wall of the sliding groove hole and abuts against an outlet of the sliding groove hole to limit the release pin.

As an improvement of the present disclosure, a clamping block is arranged at a bottom of the release pin, a groove for placing the elastic member is formed in a concave manner in a bottom of the clamping block, and one side of the clamping block extends into the sliding groove hole and is clamped with the hexagon wrench.

As an improvement of the present disclosure, each of the square opening portions includes a first square opening portion and a second square opening portion, the first square opening portion is arranged at one end of the tool body, a bottom of the first square opening portion is connected to a first sleeve portion, and a bottom of the first sleeve portion is connected to the second square opening portion; and
each of the hexagon portions is radially provided with a second connecting hole, and the hexagonal handle extends into the second connecting hole to form a handle serving as a driving end to drive the square opening portions.

As an improvement of the present disclosure, each of the hexagon portions includes a first hexagon portion and a second hexagon portion, the first hexagon portion is arranged at the other end of the tool body, a bottom of the first hexagon portion is connected to a second sleeve portion, and a bottom of the second sleeve portion is connected to the second hexagon portion; and
each of the square opening portions is radially provided with a first connecting hole, and the hexagonal handle extends into the first connecting hole to form a handle serving as a driving end to drive the hexagon portions.

As an improvement of the present disclosure, a size of the first square opening portion is 8±0.2 mm, and a size of the second square opening portion is 16±0.2 mm.

As an improvement of the present disclosure, a size of the first hexagon portion is 9.525±0.2 mm, and a size of the second hexagon portion is 19.05±0.2 mm.

As an improvement of the present disclosure, the first sleeve portion and the second sleeve portion both are of hexagonal structures, and sizes of the first sleeve portion and the second sleeve portion are 17 mm.

With such a design, the present disclosure has at least the following advantages:
1. The special-purpose valve core removal tool is provided with the multiple square opening portions and hexagon portions of different specifications, which are combined with the hexagon wrench with the tapered extractor into various forms to achieve different functions.
2. The internal hexagon hole is formed in the tool body and the release pin is arranged in the internal hexagon hole to be clamped with the hexagon wrench to combine a broken wire extractor or use the hexagon wrench as a handle.
3. The tool body is provided with the square opening portions and hexagon portions of various specifications, and in the disassembling and assembling process, it is not needed to replace the tool heads with different sizes.
4. The tool body is provided with the sleeve portion configured to match with an electric tool in use, so that rapid removal is achieved.

### BRIEF DESCRIPTION OF FIGURES

The above is merely an overview of the technical solution of the present disclosure. In order to better understand the technical means of the present disclosure, the present disclosure will be further described in detail below in conjunction with drawings and specific embodiments.

FIG. 1 is an overall schematic structural diagram of a special-purpose valve core removal tool in an embodiment of the present disclosure used as a hexagon wrench.

FIG. 2 is an overall schematic structural diagram of a special-purpose valve core removal tool in an embodiment of the present disclosure used as an extractor.

FIG. 3 is a schematic structural diagram of a tool body in the present disclosure.

FIG. 4 is a schematic structural diagram of a hexagon wrench in the present disclosure.

FIG. 5 is a cross-sectional view of a release pin in the present disclosure.

FIG. 6 is a state diagram of a release pin unlocked after being pressed in the present disclosure.

FIG. 7 is a state diagram when a release pin locks a hexagon wrench in the present disclosure.

FIG. 8 is a partially enlarged drawing of FIG. 7.

FIG. 9 is an overall schematic structural diagram of a hexagon wrench in an embodiment of a special-purpose valve core removal tool provided by the present disclosure used as a handle of a tool body.

FIG. 10 is an overall schematic structural diagram of the hexagon wrench in another using mode in FIG. 9.

### DESCRIPTION OF REFERENCE NUMERALS

1, tool body; 11, square opening portion; 111, first square opening portion; 112, second square opening portion; 113, first sleeve portion; 114, first connecting hole; 12, hexagon portion; 121, first hexagon portion; 122, second hexagon portion; 123, second sleeve portion; 124, second connecting hole; 13, internal hexagon through hole; 14, clamping portion; 141, sliding groove hole; 142, release pin; 1421, bump; 1422, clamping block; 1423, groove; 143, sealing jack screw; 144, elastic member;
2, hexagon wrench; 21, tapered extractor; 22, hexagonal handle; 221, first locking groove; and 222, second locking groove.

### DETAILED DESCRIPTION

The technical solution of the present disclosure will be clearly and completely described below in conjunction with drawings.

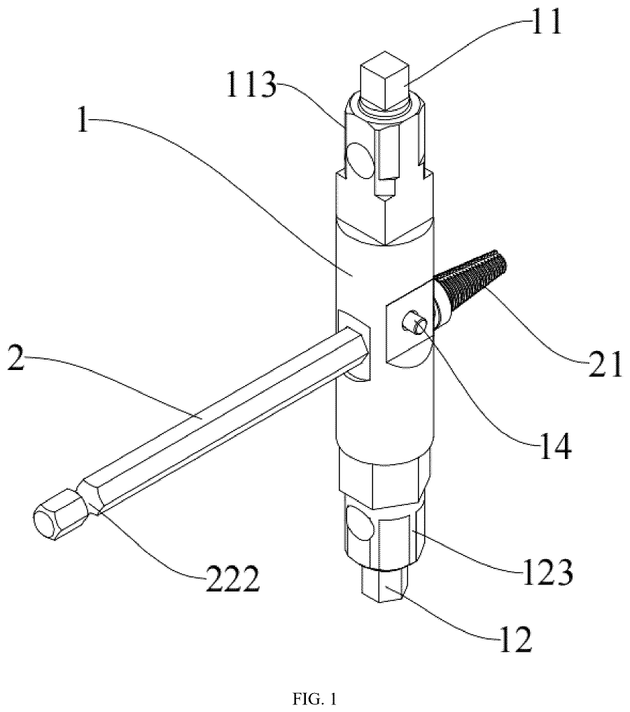

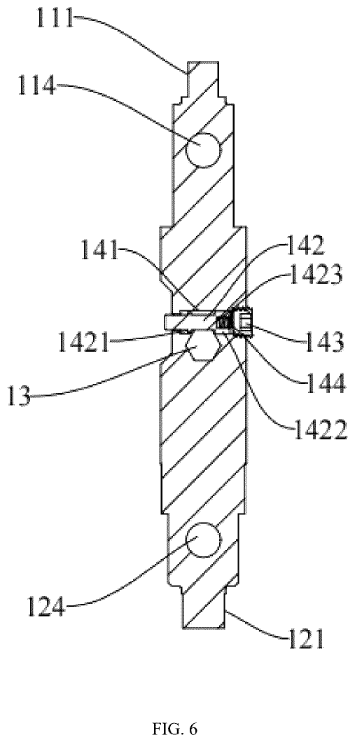

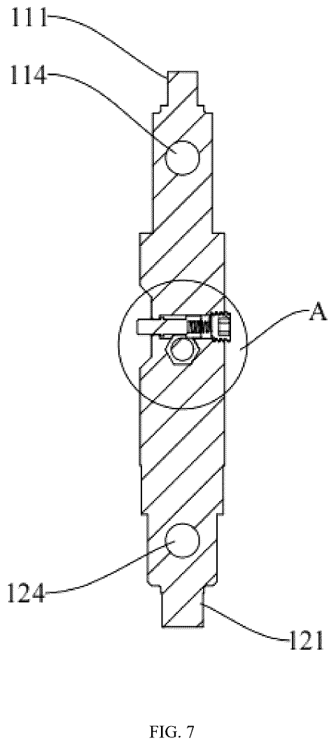

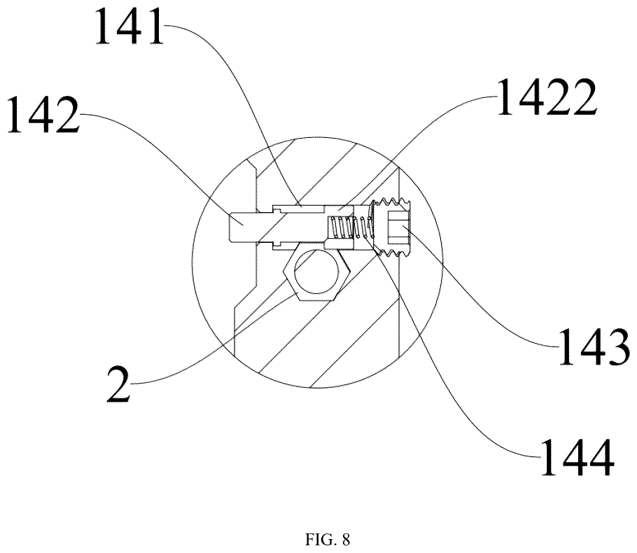

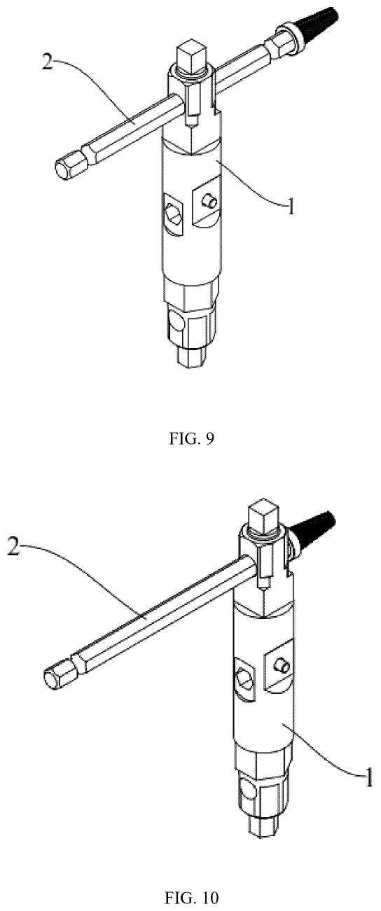

Referring to a specific embodiment of a valve core removal tool shown in FIG. 1 to FIG. 10, the special-purpose valve core removal tool can remove the faulty valve core smoothly in the disassembling and assembling process without replacing the tool heads with different sizes many times, which solves the problem that existing removal tools are mainly scattered manual tools, in the disassembling and assembling process, it is needed to replace the tool heads with different sizes, and it is hard, labor-wasting and strenuous to remove the valve core corroded in the removal process.

As shown in FIG. 1 to FIG. 10, the special-purpose valve core removal tool in this embodiment includes a tool body 1 and a hexagon wrench 2 with a tapered extractor 21. The tool body 1 is detachably connected to the hexagon wrench 2 and includes square opening portions 11, hexagon portions 12, an internal hexagon through hole 13, and a clamping portion 14. Multiple square opening portions 11 and hexagon portions 12 of different specifications are arranged axially along the tool body 1. An internal hexagon through hole 13 is formed in the middle section of the tool body 1. The clamping portion 14 is radially arranged in the tool body 1 and transversely moves along the internal hexagon through hole 13. The hexagon wrench 2 is extendable into the internal hexagon through hole 13 to be clamped with the clamping portion 14 to combine various forms, so that different functions are achieved.

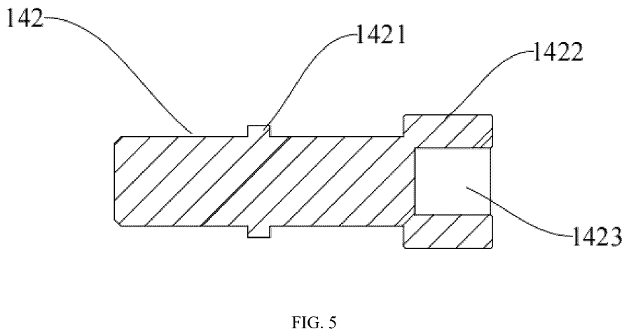

Specifically, as shown in FIG. 5 to FIG. 8, the clamping portion 14 includes a sliding groove hole 141, a release pin 142, a sealing jack screw 143, and an elastic member 144. The sliding groove hole 141 is transversely formed in the tool body 1 and is communicated with the internal hexagon through hole 13. The release pin 142 slides along the sliding groove hole 141, and one side of the release pin 142 extends into the sliding groove hole 141 to be clamped with the internal hexagon wrench 2. The sealing jack screw 143 is arranged at one end of the sliding groove hole 141. The elastic member 144 is arranged between the release pin 142 and the sealing jack screw 143 and abuts against the release pin 142 and the sealing jack screw 143, respectively. Preferably, the elastic member 144 is a spring. During use, the release pin 142 is pressed, so that the release pin 142 slides to a bottom along the sliding groove hole 141. The release pin 142 compresses the spring, the hexagon wrench 2 penetrates into the internal hexagon through hole 13, and then the release pin 142 is loosened, so that the release pin 142 is clamped with the hexagon wrench 2 through the thrust of the spring.

Further, one end of the release pin 142 extends out of the sliding groove hole 141, the release pin 142 is provided with a bump 1421, and the bump 1421 slides along an inner wall of the sliding groove hole 141 and abuts against an outlet of the sliding groove hole 141 to limit the release pin 142. Through the bump 1421, the release pin 142 can slide in the sliding groove hole 141 and limits the release pin 142 in the sliding groove hole 141.

Further, a clamping block 1422 is arranged at a bottom of the release pin 142, a groove 1423 for placing the elastic member 144 is formed in a concave manner in a bottom of the clamping block 1422, and one side of the clamping block 1422 extends into the sliding groove hole 141 and is clamped with the hexagon wrench 2. The circular clamping block 1422 is arranged at the bottom of the release pin 142, the clamping block 1422 abuts against the inner wall, and one side of the clamping block 1422 extends into a place where the sliding groove hole 141 is communicated with the internal hexagon through hole 13. The release pin 142 is pressed, so that the clamping block 1422 slides to the bottom of the sliding groove hole 141. The hexagon wrench 2 penetrates into the internal hexagon through hole 13. Then the release pin 142 is loosened. An elastic force is applied by the spring to the release pin 142, so that the release pin 142 is reset. The clamping block 1422 extends to the position of the internal hexagon through hole 13 and slides to be clamped with the hexagon wrench 2, so as to fix the hexagon wrench 2 in the hexagon through hole 13.

### Embodiment I

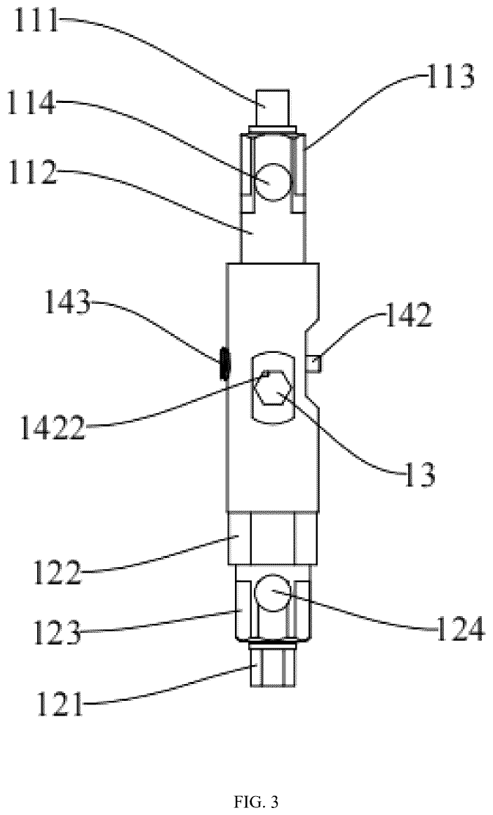

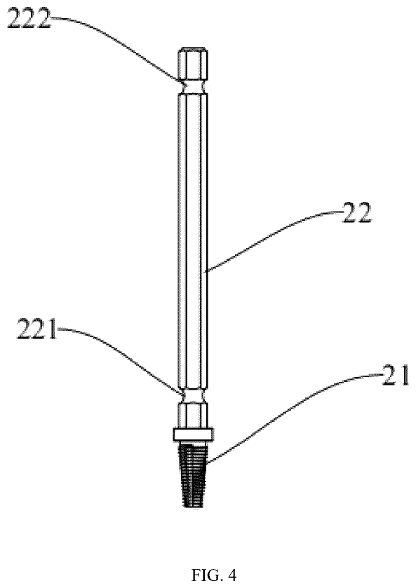

As shown in FIG. 3 and FIG. 4, the hexagon wrench 2 includes: a hexagonal handle 22, where a tapered extractor 21 is arranged at one end of the hexagonal handle 22; a first locking groove 221 and a second locking groove 222 are radially formed in a concave manner in both ends of the hexagonal handle 22, the first locking groove 221 is formed at an end close to the tapered extractor 21, and the second locking groove 222 is formed at the other end; and the hexagon wrench 2 can be independently used as an 8 mm hexagon wrench 2.

### Embodiment II

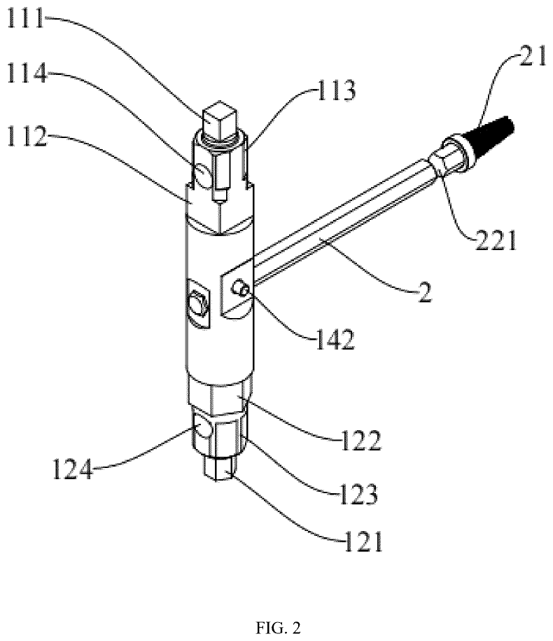

Specifically, as shown in FIG. 2, the hexagonal handle 22 extends into the internal hexagon through hole 13, the release pin 142 is clamped with the second locking groove 222, and the tool body 1 is combined with the hexagon handle 2 to form a broken wire extractor. When the release pin 142 is clamped with the second locking groove 222, the combined overall structure is T-shaped. An operator holds the tool body 1 as a handheld handle. The tapered extractor 21 is located at a bottom of the hexagon handle 2 and is used as the broken wire extractor.

### Embodiment III

As shown in FIG. 1, the hexagonal handle 22 extends into the internal hexagon through hole 13, the release pin 142 is clamped with the first locking groove 221, and the tool body 1 is configured to form a handheld portion of the hexagon handle 2. The combined overall structure is T-shaped. The tool body 1 serves as a handheld handle. The bottom of the hexagonal handle 22 is used as an 8 mm hexagon handle 2.

It can be understood that the internal hexagon through hole 13 can be formed either at the center of the tool body 1 or at other positions of the tool body 1 to play a role of the handle.

### Embodiment IV

As shown in FIG. 3 to FIG. 10, each of the square opening portions 11 includes a first square opening portion 111 and a second square opening portion 112, the first square opening portion 111 is arranged at one end of the tool body 1, a bottom of the first square opening portion 111 is connected to a first sleeve portion 113, a bottom of the first sleeve portion 113 is connected to the second square opening portion 112, the first sleeve portion 113 is radially provided with a first connecting hole 114, and the hexagonal handle 22 extends into the first connecting hole 114 to form the handle. A size of the first square opening portion 111 is 8±0.2 mm, and a size of the second square opening portion 112 is 16±0.2 mm, so that corresponding square opening portions can be used when different sizes are needed. The tool can match with an electric tool in use through the first sleeve portion 113. The electric tool is placed in the first sleeve portion 113 for driving. The hexagon portion 12 serves as one end of the removal tool for removal work.

### Embodiment V

As shown in FIG. 3 to FIG. 10, each of the hexagon portions 12 includes a first hexagon portion 121 and a second hexagon portion 122, the first hexagon portion 121 is arranged at the other end of the tool body 1, a bottom of the first hexagon portion 121 is connected to a second sleeve portion 123, a bottom of the second sleeve portion 123 is connected to the second hexagon portion 122, the second sleeve portion 123 is radially provided with a second connecting hole 124, and the hexagonal handle 22 extends into the second connecting hole 124 to form the handle. A size of the first hexagon portion 121 is 9.525±0.2 mm, and a size of the second hexagon portion 122 is 19.05±0.2 mm, so that corresponding hexagon portions can be used when different sizes are needed. The tool can match with an electric tool in use through the second sleeve portion 123. The electric tool is placed in the second sleeve portion 123 for driving. The square opening portion 11 serves as one end of the removal tool for removal work.

It should be noted that the first connecting hole 114 and the second connecting hole 124 are movably connected to the hexagonal handle 22. The connection between the hexagonal handle 22 and the first connecting hole 114 or the second connecting hole 124 can be located either in the middle of the hexagonal handle 22 or at both ends of the hexagonal handle 22, which aims to increase the distance from the hexagonal handle 22 to the tool body 1, so as to increase the moment arm distance. The larger the moment arm is, the larger the moment generated by a force with the same magnitude is. Therefore, it is labor-and trouble-saving to remove the valve core.

It can be understood that when the hexagon portions are used, the hexagonal handle 22 is inserted into the first connecting hole 114. The hexagonal handle 22 is the portion handheld by the operator. The hexagon portions 12 can be in different sizes of 9.525±0.2 mm and 19.05±0.2 mm as needed. When the square opening portions 11 are used, the hexagonal handle 22 is inserted into the second connecting hole 124. The hexagonal handle 22 is the portion handheld by the operator. The square opening portions 11 can be in different sizes of 8 mm and 16 mm as needed. The first sleeve portion 113 and the second sleeve portion 123 both are of hexagonal structures. Sizes of the first sleeve portion 113 and the second sleeve portion 123 are 17 mm. The sleeve portions can either be used as hexagon tools or connected to the electric tool for rapid removal.

In the description of the present disclosure, it should be understood that, the orientation or positional relationship indicated by the term “upper”, “lower”, “front”, “rear” or the like is based on the orientation or positional relationship shown in the accompanying drawings. This is only for the convenience of describing the present disclosure and simplifying the description, and does not indicate or imply that a device or element must have a specific orientation, or be constructed and operated in a specific orientation, and therefore cannot be understood as a limitation of the present disclosure.

In the description of this application, it should be noted that unless otherwise explicitly specified or defined, the terms such as “install”, “connect”, and “connection” should be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two components. For those of ordinary skill in the art, the specific meanings of the aforementioned terms in the present disclosure can be understood according to specific conditions.

The foregoing descriptions are merely exemplary embodiments of the present disclosure, and are not intended to limit the present disclosure in any form. Some simple amendments, equivalent changes or modifications made by those skilled in the art based on the technical contents disclosed above shall fall within the protection scope of the present disclosure.

What is claimed is:

1. A special-purpose valve core removal tool, comprising:
a tool body and a hexagon wrench with a tapered extractor, wherein the tool body is detachably connected to the hexagon wrench;
the tool body comprises square opening portions, hexagon portions, and a clamping portion, wherein a plurality of square opening portions and hexagon portions of different specifications are arranged axially along the tool body, an internal hexagon through hole is formed in a middle section of the tool body, the internal hexagon through hole radially penetrates through the tool body, and the clamping portion is radially arranged in the tool body and transversely moves along the internal hexagon through hole; and
the hexagon wrench is extendable to the internal hexagon through hole to be clamped with the clamping portion.

2. The special-purpose valve core removal tool according to claim 1, wherein the hexagon wrench comprises a hexagonal handle, the tapered extractor is arranged at one end of the hexagonal handle, a first locking groove and a second locking groove are radially formed in a concave manner in both ends of the hexagonal handle, the first locking groove is formed at an end close to the tapered extractor, and the second locking groove is formed at the other end; and
the hexagon wrench extends into the internal hexagon through hole, and the clamping portion is clamped with the first locking groove or the second locking groove.

3. The special-purpose valve core removal tool according to claim 1, wherein the clamping portion comprises:
a sliding groove hole, a release pin, a sealing jack screw, and an elastic member, wherein the sliding groove hole is transversely formed in the tool body and is communicated with the internal hexagon through hole;
the release pin slides along the sliding groove hole and one side of the release pin extends into the sliding groove hole and is clamped with the hexagon wrench; and
the sealing jack screw is arranged at one end of the sliding groove hole, and the elastic member is arranged between the release pin and the sealing jack screw and abuts against the release pin and the sealing jack screw, respectively.

4. The special-purpose valve core removal tool according to claim 2, wherein one end of the release pin extends out of the sliding groove hole, the release pin is provided with a bump, and the bump slides along an inner wall of the sliding groove hole and abuts against an outlet of the sliding groove hole to limit the release pin.

5. The special-purpose valve core removal tool according to claim 2, wherein a clamping block is arranged at a bottom of the release pin, a groove for placing the elastic member is formed in a concave manner in a bottom of the clamping block, and one side of the clamping block extends into the sliding groove hole and is clamped with the hexagon wrench.

6. The special-purpose valve core removal tool according to claim 1, wherein each of the square opening portions comprises a first square opening portion and a second square opening portion, the first square opening portion is arranged at one end of the tool body, a bottom of the first square opening portion is connected to a first sleeve portion, and a bottom of the first sleeve portion is connected to the second square opening portion; and
each of the hexagon portions is radially provided with a second connecting hole, and the hexagonal handle extends into the second connecting hole to form a handle serving as a driving end to drive the square opening portions.

7. The special-purpose valve core removal tool according to claim 6, wherein each of the hexagon portions comprises a first hexagon portion and a second hexagon portion, the first hexagon portion is arranged at the other end of the tool body, a bottom of the first hexagon portion is connected to a second sleeve portion, and a bottom of the second sleeve portion is connected to the second hexagon portion; and
each of the square opening portions is radially provided with a first connecting hole, and the hexagonal handle extends into the first connecting hole to form a handle serving as a driving end to drive the hexagon portions.

8. The special-purpose valve core removal tool according to claim 6, wherein a size of the first square opening portion is 8±0.2 mm, and a size of the second square opening portion is 16±0.2 mm.

9. The special-purpose valve core removal tool according to claim 7, wherein a size of the first hexagon portion is 9.525±0.2 mm, and a size of the second hexagon portion is 19.05±0.2 mm.

10. The special-purpose valve core removal tool according to claim 7, wherein the first sleeve portion and the second sleeve portion both are of hexagonal structures, and sizes of the first sleeve portion and the second sleeve portion are 17 mm.
